(19) United States
(12) Patent Application Publication
(10) Pub. No.: US 2010/0030548 A1
(43) Pub. Date: Feb. 4, 2010

(54) METHOD FOR DISPLAYING SOFTWARE APPLICATIONS IN A SECONDARY LANGUAGE WHILE INTERACTING AND VIEWING THE DEFAULT LANGUAGE VERSION

(75) Inventors: Janice R. Glowacki, Rochester, MN (US); John Edward Petri, Lewiston, MN (US)

Correspondence Address: ZILKA-KOTAB, PC- IBMS, P.O. BOX 721120, SAN JOSE, CA, 95172-1120, US

(73) Assignee: International Business Machines Corporation, Armonk, NY (US)

(21) Appl. No.: 12/184,110

(22) Filed: Jul. 31, 2008

(51) Int. Cl. G06F 17/28

(52) U.S. Cl. 704/3

(57) ABSTRACT

A method in one embodiment includes selecting an application under test; selecting one or more secondary human languages; starting a single instance of the application under test; receiving input via a first window displaying data from the application in a primary human language, the input invoking steps in a testing sequence; and evaluating a response of the application to the input received via the first window. A response of the application is output to each step in the testing sequence in one or more secondary windows to the one or more selected secondary human languages by: looking up text used in the step from the first window using the default language resource bundle for the application under test; finding the resource bundle “keys” associated with the default language text used in the step; using the keys to look up translated text used in the step within the secondary language resource bundles for the application under test; and running the automated step in the one or more secondary windows by substituting the secondary language texts to identify objects on the secondary screens using the test automation software.

### BACKGROUND

The present invention relates to application programs, and more particularly, this invention relates to a method for displaying software applications in a secondary language while interacting and viewing the default language version.

During National Language Translation (NLT) verification of an application program, the translation testers follow a test plan provided by the developers. In general, the test plan directions for using the product with supporting screen captures are in English (or the native language of the developer). The document describes how the tester is to use the application under test to verify the translated screens and messages. The translation tester typically must follow the document exactly in order to have success with the verification. Unfortunately, more often than not, either the document fails to provide correct steps or the translation tester inadvertently/unintentionally deviates and is unable to successfully follow the plan.

When problems are encountered with the plan (as well as with the product under test), the translation tester presents such issues to the developers. These issues cause delays due to very time-consuming resolutions (time-zone considerations and language barriers cause much delay). There is therefore a need for automating the test plan and translation verification process (so that translation testers can focus on verifying screens and messages without having to spend much effort learning/using the product under test). This would be a great time saver and thus improve product delivery schedules.

Using test automation to aid in translation verification has failed in the past, primarily because automated test scripts only work with a single language. This is because the script recording mechanisms of current test automation tools capture the actual text on the user's screen. Even in cases when a developer creates the test scripts by writing code (e.g. using regular expressions for more robust pattern matching of objects), a particular language must be assumed. For example, a regular expression to match a partial English phrase on a dialog of the application under test may be completely different than the same phrase in Spanish. Therefore, pre-recorded or pre-built automated test scripts alone cannot be used to effectively automate National Language Verification NLV testing.

### SUMMARY

A method in one embodiment includes selecting an application under test; selecting one or more secondary human languages; starting a single instance of the application under test; receiving input via a first window displaying data from the application in a primary human language, the input invoking steps in a testing sequence; and evaluating a response of the application to the input received via the first window. A response of the application is output to each step in the testing sequence in one or more secondary windows in the one or more selected secondary human languages by: looking up text used in the step from the first window using the default language resource bundle for the application under test; finding the resource bundle “keys” associated with the default language text used in the step; using the keys to look up translated text used in the step within the secondary language resource bundles for the application under test; and running the automated step in the one or more secondary windows by substituting the secondary language texts to identify objects on the secondary screens using the test automation software.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

FIG. 1 is a flow diagram of a method according to one general embodiment.

FIG. 2 depicts the process of operation 112 of FIG. 1.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

In some embodiments, the invention relates to a computer program that runs a single instance of an application and simultaneously displays output from the application in multiple windows, each in a different human language, which may be a national language such as English, Spanish, French, German, Japanese, Chinese, or any other language. Such embodiments are particularly useful for improving how national language test verification is performed.

In one approach, an application allows a user, automated program, etc. to interact with a single instance of an application under test and display it in multiple windows simultaneously (e.g., two or more windows), thereby allowing the user or test automation software (e.g. such as Rational Functional Tester) to control the application in the main window and view the results in both the main and secondary windows.

In one particularly preferred approach, the first (or “main”) window is the full application, accepting input (either manual or automated) and displaying output in the default language. The secondary window or windows present essentially the same screens of the running application but in their selected languages. The secondary window(s) are driven in a limited fashion. That is, the test automation input is driven primarily from the first window to allow the test scripts developed for the default language to execute successfully, and then based on each step of the script, both the first and secondary window(s) are updated simultaneously to reflect the current state of the application under test.

With various embodiments of the present invention, a user or test automation software only interacts with the application under test once but can view screens in English (or default language) and in one or multiple other languages. The user or test automation software drives testing from the main window, resulting in related actions being executed in the second window; thus making this solution different than running the application under test in two sessions and having to interact with both sessions to keep the displays synchronized.

For translation testing, developers may pre-record or pre-build the test scripts using any number of record-and-playback test software or by writing the scripts in code. Then, the pre-recorded/pre-built scripts may be executed using automation software. Moreover, the exact English screens and messages along with the translation text for a secondary language may be output to a user, e.g., a translator. The translator is then able to focus on verifying the text without having to struggle to follow manual test instructions.

Because current test automation approaches are tied to a particular language, the teachings herein represent a significant step forward for NLV testing productivity. In other words, with current art any regular expression in a test script that is written in the default language (e.g. English) for matching objects in the application under test will rarely work as intended when the application is automated in a non-default language. Thus various approaches outlined herein fill a much needed gap in this space.

Other embodiments may be used for demonstrations so that, for example, an English speaking user is allowed to interact with the application in English (working on one display) while a screen or screens with a second (and optionally, third, fourth, etc.) language is/are output on a second (and/or third, fourth, etc.) display.

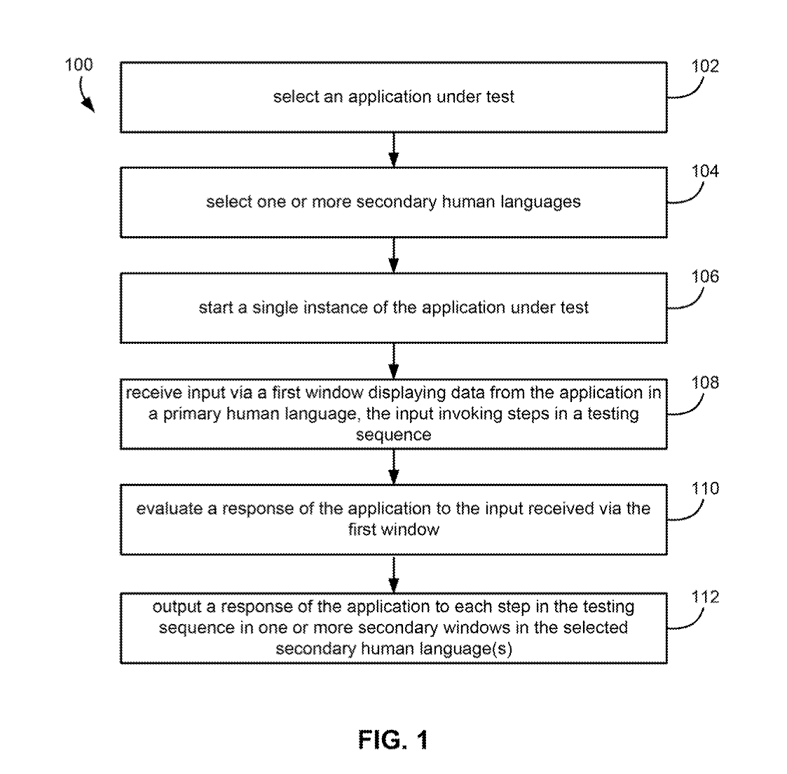

FIG. 1 depicts a method 100 according to one embodiment. In operation 102, an application under test is selected (e.g., URL, java application, etc).

In operation 104, one or more secondary human languages are selected. Message resources may also be identified. Note that the selection may be automatic if there is only one choice of a secondary language. One particular secondary language can be selected by default, optionally with the ability to select a different or additional secondary languages. In some approaches, a list of available secondary language choices may be presented to a user for selection.

In operation 106, a single instance of the application is started. The default language is presented in the main window and allows for input.

In operation 108, input is received via a first window that displays data from the application in a primary human language, the input invoking steps in a testing sequence. Note that the input can be automated or manual. For example, the automated input can be generated by running a test script, running an automated testing program, etc. Manual input may include input directly from a user.

In operation 110, a response of the application to the input received via the first window is evaluated. For example, as the user or test automation software interacts with the first window, the test automation artifacts are invoked as designed (e.g. by evaluating pre-recorded steps and/or regular expressions in the default language).

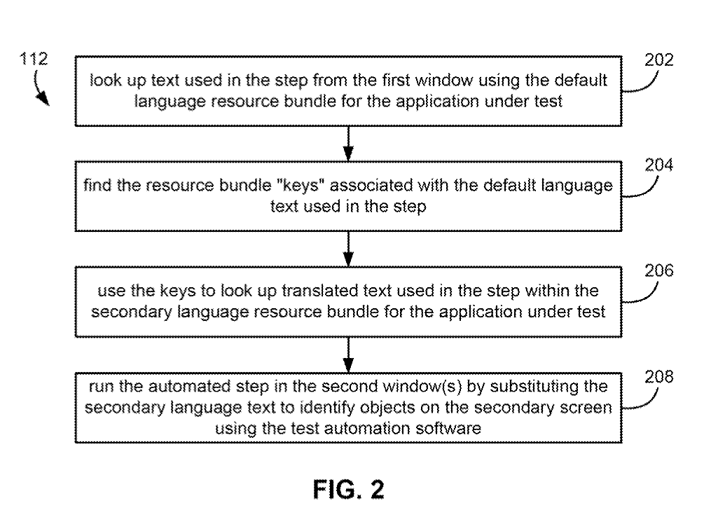

In operation 112, a response of the application to each step in the testing sequence is output in one or more secondary windows in the secondary human language(s). For example, after each step in the automated test script is performed in the main window (i.e., in the default language), the same step is performed in the secondary window(s) by performing the steps in FIG. 2.

FIG. 2 depicts the process of operation 112 of FIG. 1.

In operation 202, text used in the step from the main window is looked up using the default language resource bundle for the application under test.

In operation 204, the resource bundle “keys” associated with the default language text used in the step are found.

In operation 206, the keys are used to look up translated text used in the step within the secondary language resource bundles for the application under test. For example, shown in Table 1 are illustrative default and Italian resources for a few messages.

TABLE 1

| Key and TEXT from | Key and TEXT from the |
|---|---|
| Default Language Resource Bundle | Italian Resource Bundle |
| HomepageContent_CreateQuery = Create | HomepageContent_CreateQuery = Crea |
| a new query | nuova query |
| HomepageContent_AuthorizeDesc = Click | HomepageContent_AuthorizeDesc = Fare |
| here to provide different | clic qui per fornire dati di |
| authorization information. By providing | authorizzazione differenti. Fornendo dati di |
| different authorization information, you | autorizzazione differenti, \u00e8 possibile |
| can change your access rights to different | cambiare i propri diritti di accesso ai vari |
| data within the warehouse. | dati all'interno del warehouse. |
| Menu_Tools = Tools | Menu_Tools = Strumenti |
| CT_UserGuide = User's Guide | CT_UserGuide = Guida dell'utente |

In addition, a translation operation may be performed on other forms of output like audio, video, pictorial, etc. which may also be used to drive primary and secondary test steps/objects

In operation 208, the automated step is run in the secondary window(s) by substituting the secondary language text to identify objects on the secondary screen(s) using the test automation software.

Other embodiments of the present invention can be used to record/playback test scripts whereby the message KEYs are preserved in test scripts (or with other test artifacts) rather than the default/English text. When this is the case, step 112 of FIG. 1 can be viewed as:
After each interaction with the main window (default language), the same step is programmatically performed in the secondary windows as follows when in manual or automated input mode:
   Manual input (such as interactive input including record mode to create an automation script):
      Looking up the text used in the step from the main window using the default language resource bundle for the application under test.
      Subsequently finding the resource bundle “keys” associated with the default language text used in the step.
      Using the keys to look up the translated text used in the step within the secondary language resource bundles for the application under test.
      Preserves the message KEY in the test script (or elsewhere with the test artifacts)
      Runs the identical interaction from the main window in the secondary windows by substituting the secondary language text to identify objects on the secondary screens.
   Automated input mode (such as playback of a recorded automation script):
      Using the message keys in the test script (or test artifacts) to look up the translated text used in the step within the secondary language resource bundles for the application under test.
      Runs the identical automated step from the main window in the secondary windows by substituting the secondary language text to identify objects on the secondary screens.

It should be noted that, the invention can take the form of an embodiment containing both hardware and software elements. In one embodiment, the invention may be implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method, comprising:
selecting an application under test;
selecting one or more secondary human languages;
starting a single instance of the application under test;
receiving input via a first window displaying data from the application in a primary human language, the input invoking at least one step in a testing sequence;
evaluating a response of the application to the input received via the first window; and
outputting a response of the application to the at least one step in the testing sequence in one or more secondary windows in the one or more selected secondary human languages by:
looking up text used in the at least one step from the first window using the default language resource bundle for the application under test;
finding the resource bundle keys associated with the default language text used in the at least one step;
using the keys to look up translated text used in the at least one step within the secondary language resource bundles for the application under test; and
running at least one automated step in the one or more secondary windows by substituting the secondary language texts to identify objects on the one or more secondary windows using a test automation software.
